(19) United States
(12) Patent Application Publication
(10) Pub. No.: US 2021/0337159 A1
(43) Pub. Date: Oct. 28, 2021

(54) INTERFACE APPARATUS AND DISPLAY APPARATUS

(71) Applicants: K-TRONICS (SUZHOU) TECHNOLOGY CO., LTD., Suzhou (CN); BOE TECHNOLOGY GROUP CO., LTD., Beijing (CN)

(72) Inventor: Kai CHENG, Beijing (CN)

(21) Appl. No.: 16/335,954

(22) PCT Filed: Sep. 7, 2018
(86) PCT No.: PCT/CN2018/104590

§ 371 Date: Mar. 22, 2019

(30) Foreign Application Priority Data
Sep. 27, 2017 (CN) 201710890350.3

(51) Int. Cl. H04N 5/63; H04N 21/4363

(52) U.S. Cl. CPC H04N 5/63; H04N 21/43635

(57) ABSTRACT

The present disclosure provides an interface apparatus and a display apparatus. The interface apparatus is provided with a power supply circuit and an HDMI receptacle. The power supply circuit is coupled to a first power source and the HDMI receptacle, and is configured to convert a first voltage from the first power source into a preset voltage and provide the preset voltage to the HDMI receptacle. The HDMI receptacle is configured to output the preset voltage to an external device coupled to the HDMI receptacle.

### CROSS REFERENCE TO RELATED APPLICATIONS

This patent application is a National Stage Entry of PCT/CN2018/104590 filed on Sep. 7, 2018, which claims the benefit and priority of Chinese Patent Application No. 201710890350.3 filed on Sep. 27, 2017, the disclosures of which are incorporated by reference herein in their entirety as part of the present application.

### BACKGROUND

The present disclosure relates to the field of telecommunication technologies, and more particularly, to an interface apparatus and a display apparatus.

A compute stick may be known as a High Definition Multimedia Interface (HDMI) microcomputer host. The existing compute stick on the market is connected to a display device through an HDMI interface, so as to form a computer.

The compute stick is provided with a power input terminal. The power input terminal of the compute stick is connected to an external power supply through a power adapter. In this way, the external power supply may supply power to the compute stick through the power adapter. Typically, the compute stick has a nominal input voltage of 5V and a nominal input current of 2 A.

### BRIEF DESCRIPTION

The present disclosure provides an interface apparatus and a display apparatus, which may provide a power source to a compute stick through an HDMI interface.

A first aspect of the present disclosure provides an interface apparatus. The interface apparatus includes a power supply circuit and an HDMI receptacle. The power supply circuit is coupled to a first power source and the HDMI receptacle, and is configured to convert a first voltage from the first power source into a preset voltage and provide the preset voltage to the HDMI receptacle. The HDMI receptacle is configured to output the preset voltage to an external device coupled to the HDMI receptacle.

In some embodiments of the present disclosure, the power supply circuit includes a first rectifying circuit and a voltage conversion circuit. The first rectifying circuit is coupled to the first power source and the voltage conversion circuit, and the voltage conversion circuit is coupled to the HDMI receptacle. The first rectifying circuit is configured to rectify the first voltage and provide the rectified first voltage to the voltage conversion circuit. The voltage conversion circuit converts the rectified first voltage into the preset voltage, and provides the preset voltage to the HDMI receptacle.

In some embodiments of the present disclosure, the voltage conversion circuit includes a direct current voltage converting chip.

In some embodiments of the present disclosure, the first rectifying circuit includes a plurality of capacitors in parallel. A positive electrode of each of the plurality of capacitors is coupled to the voltage input terminal, and a negative electrode of each of the plurality of capacitors is grounded.

In some embodiments of the present disclosure, the power supply circuit further includes a second rectifying circuit. The second rectifying circuit is coupled between the voltage conversion circuit and the HDMI receptacle. The second rectifying circuit is configured to rectify the preset voltage and provide the rectified preset voltage to the HDMI receptacle.

In some embodiments of the present disclosure, the second rectifying circuit includes a plurality of capacitors in parallel. A positive electrode of each of the plurality of capacitors is coupled to the HDMI receptacle, and a negative electrode of each of the plurality of capacitors is grounded.

In some embodiments of the present disclosure, the plurality of capacitors in the first rectifying circuit include electrolytic capacitors, and the plurality of capacitors in the second rectifying circuit include electrolytic capacitors.

In some embodiments of the present disclosure, the plurality of capacitors in the first rectifying circuit include electrolytic capacitors and ceramic capacitors.

In some embodiments of the present disclosure, the plurality of capacitors in the second rectifying circuit include electrolytic capacitors and ceramic capacitors.

In some embodiments of the present disclosure, the power supply circuit is coupled to a given pin of the HDMI receptacle.

In some embodiments of the present disclosure, the given pin is an eighteenth pin of the HDMI receptacle.

In some embodiments of the present disclosure, the HDMI receptacle is coupled to an HDMI plug of the external device. The preset voltage is provided to the external device via the HDMI receptacle and the HDMI plug.

In some embodiments of the present disclosure, the external device is a compute stick.

A second aspect of the present disclosure provides a display apparatus. The display apparatus includes the interface apparatus according to the first aspect of the present disclosure.

### BRIEF DESCRIPTION OF THE DRAWINGS

To describe technical solutions of the embodiments of the present disclosure more clearly, the accompanying drawings of the embodiments will be briefly introduced in the following. It should be known that the accompanying drawings in the following description merely involve with some embodiments of the present disclosure, but not limit the present disclosure, in which:

FIG. 1 illustrates a schematic block diagram of an interface apparatus according to an embodiment of the present disclosure;

FIG. 2 illustrates a schematic block diagram of an interface apparatus according to a further embodiment of the present disclosure;

FIG. 3 illustrates a schematic block diagram of an interface apparatus according to a still further embodiment of the present disclosure;

FIG. 4 illustrates an exemplary circuit diagram of a power supply circuit in the interface apparatus as shown in FIG. 3; and

FIG. 5 illustrates a schematic block diagram of a display apparatus including an interface apparatus according to an embodiment of the present disclosure.

### DETAILED DESCRIPTION

To make the technical solutions and advantages of the embodiments of the present disclosure clearer, the technical solutions in the embodiments of the present disclosure will be described clearly and completely below, in conjunction with the accompanying drawings in the embodiments of the present disclosure. Obviously, the described embodiments are merely some but not all of the embodiments of the present disclosure. All other embodiments obtained by those skilled in the art based on the described embodiments of the present disclosure without creative efforts shall fall within the protecting scope of the present disclosure.

Unless otherwise defined, all terms (including technical and scientific terms) used herein have the same meaning as commonly understood by those skilled in the art to which the present disclosure belongs. It will be further understood that terms, such as those defined in commonly used dictionaries, should be interpreted as having a meaning that is consistent with their meaning in the context of the specification and will not be interpreted in an idealized or overly formal sense unless expressly so defined herein. As used herein, the description of “connecting” or “coupling” two or more parts together should refer to the parts being directly combined together or being combined by way of one or more intermediate components.

As a digital video/audio interface technology, an HDMI is a special digital interface fit for audio and video transmission. The HDMI interface may simultaneously transmit audio and video signals. The HDMI interface has a maximum data transmission rate of 2.25 GB/s. The HDMI interface may be classified into four types, i.e., Type A, Type B, Type C, and Type D. The Type A HDMI interface is the most common HDMI interface. Generally, flat-panel televisions or video devices are provided with the Type A HDMI interface. The Type A HDMI interface has 19 pins, and has a width of 13.9 mm and a thickness of 4.45 mm. Most of the existing devices on the market are provided with the Type A HDMI interface. The Type B HDMI interface has 29 pins, and has a width of 21 mm, and its transmission bandwidth is nearly twice as wide as that of the Type A HDMI interface. The Type B HDMI interface is mainly used in some professional occasions. The Type C HDMI interface is used in small-sized devices, and has a size of 10.42×2.4 mm, which is smaller than the Type A HDMI interface by nearly ⅓. By adopting a dual inline-pin package (DIP) design, the Type D HDMI interface is further reduced in size, and is approximate to a miniUSB interface. Therefore, the Type D HDMI interface is more suitable for portable devices and vehicle-mounted devices.

An HDMI interface of a display device can provide a 5V voltage, but cannot output a 2 A current. Therefore, this type of HDMI interface cannot provide power required for a compute stick. The compute stick needs to be additionally equipped with a power adapter, which is used to supply power to the compute stick via an external power supply. Using this type of HDMI interface not only increases costs, but also is not convenient.

An embodiment of the present disclosure provides an interface apparatus, which may provide a power source to an external device such as a compute stick through an HDMI interface.

FIG. 1 illustrates a schematic block diagram of an interface apparatus according to an embodiment of the present disclosure. The interface apparatus includes a power supply circuit 10 and an HDMI receptacle 20. The power supply circuit 10 is coupled to a first power source V1 and the HDMI receptacle 20. The power supply circuit 10 is configured to convert a first voltage from the first power source V1 into a preset voltage and provide the preset voltage to the HDMI receptacle 20. The HDMI receptacle 20 is configured to output the preset voltage to an external device coupled to the HDMI receptacle 20.

In some embodiments of the present disclosure, the first power source V1 may be, for example, a DC power source converted from mains supply, and can supply, for example, a power much higher than 10 W. The first power source V1 can supply a first voltage of 12V or 15V, for example. The first voltage is supplied to the power supply circuit 10. The power supply circuit 10 may convert the inputted first voltage into the preset voltage as required. In some embodiments of the present disclosure, the preset voltage may be preset based on actual situations of the external device.

For example, the preset voltage is 5V if the external device is the compute stick. The power supply circuit 10 supplies, to the HDMI receptacle 20, the preset voltage obtained from conversion. The HDMI receptacle 20 may supply the preset voltage to, for example, the compute stick coupled to the HDMI receptacle 20. The first power source V1 can supply a power much higher than 10 W, and thus the electrical signal obtained from conversion can supply a 2 A current to the compute stick. Thus, the interface apparatus according to some embodiments of the present disclosure may not only perform data communication with the compute stick, but also may provide a power source for the compute stick. Those skilled in the art should understand that the interface apparatus according to some embodiments of the present disclosure may not only provide the power source for the compute stick, but also may provide the power source for other external devices. The interface apparatus according to some embodiments of the present disclosure may convert a corresponding preset voltage based on a voltage required for the external device coupled to the interface apparatus. Thus, the interface apparatus according to some embodiments of the present disclosure may not only perform data communication with the external device, but also may provide the power source for the external device.

The interface apparatus according to some embodiments of the present disclosure may provide the power source for the external devices through the HDMI interface, such that the external device is not needed to be additionally equipped with a power adapter. Thus, using the interface apparatus not only saves costs, but also is convenient for use.

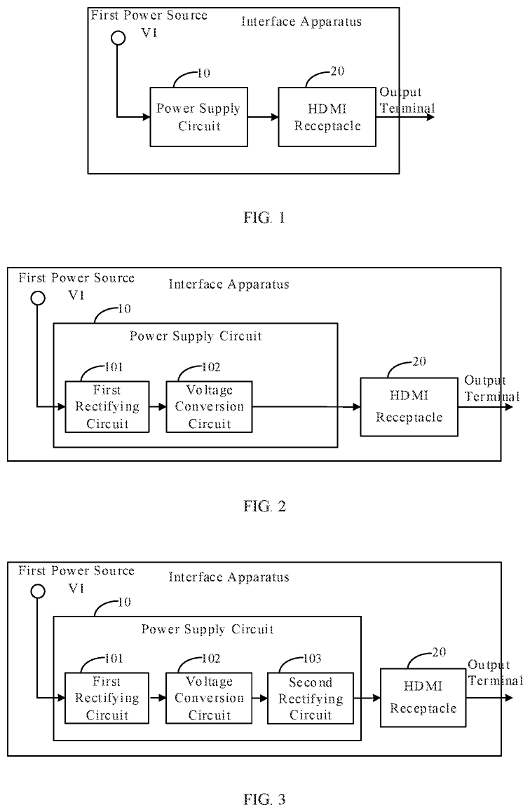

FIG. 2 illustrates a schematic block diagram of an interface apparatus according to a further embodiment of the present disclosure. As shown in FIG. 2, the power supply circuit 10 includes a first rectifying circuit 101 and a voltage conversion circuit 102. The first rectifying circuit 101 is coupled to the first power source V1 and the voltage conversion circuit 102. The voltage conversion circuit 102 is coupled to the HDMI receptacle 20.

Because the first power source V1 may be a DC power source converted from mains supply, a ripple wave may exist in the first voltage. The first rectifying circuit 101 is configured to rectify the first voltage and provide the rectified first voltage to the voltage conversion circuit 102. In this way, compared with the first voltage before the rectification, the rectified first voltage has a higher signal-to-noise ratio.

The voltage conversion circuit 102 converts the rectified first voltage into the preset voltage, and provides the preset voltage to the HDMI receptacle.

FIG. 3 illustrates a schematic block diagram of an interface apparatus according to a still further embodiment of the present disclosure. On the basis of the interface apparatus as shown in FIG. 2, the power supply circuit 10 also includes a second rectifying circuit 103. The second rectifying circuit is coupled between the voltage conversion circuit and the HDMI receptacle.

The second rectifying circuit 103 is configured to rectify the preset voltage and provide the rectified preset voltage to the HDMI receptacle 20. In this way, compared with the preset voltage before the rectification, the rectified preset voltage will have a higher signal-to-noise ratio.

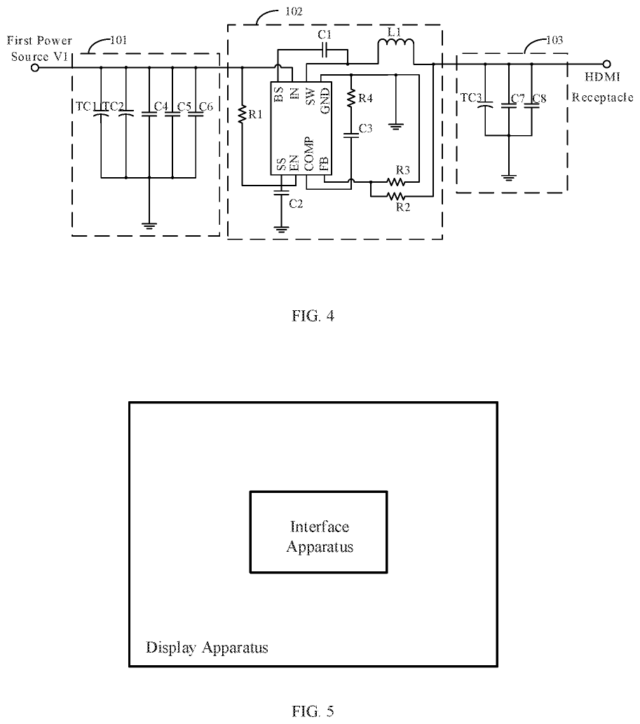

Referring to the circuit diagram of the power supply circuit as shown in FIG. 4, in some embodiments of the present disclosure, the voltage conversion circuit 102 may include a direct current voltage converting chip. In some embodiments of the present disclosure, the direct current voltage converting chip may be an FR9889 DC-DC voltage converting chip. The FR9889 DC-DC voltage converting chip is provided with eight ports. These ports include a gate drive boost pin BS, a power supply input pin IN, a power switching output pin SW, a grounded pin GND, a soft-start pin SS, an enable input pin EN, an open drain power output pin COMP, and a voltage feedback input pin FB. The power supply input pin IN is connected to the first power source V1. A first capacitor C1 is connected between the gate drive boost pin BS and the power switching output pin SW. A second capacitor C2 is connected between the soft-start pin SS and the grounded pin GND. A first resistor R1 is connected between the enable terminal EN and the first power source V1. A second resistor R2 and a first inductor L1 are connected between the voltage feedback input pin FB and the power switching output pin SW. A third resistor R3 is connected between the voltage feedback input pin FB and the grounded pin GND. A third capacitor C3 and a fourth resistor R4 are connected between the open drain power output pin COMP and the grounded pin GND. A node between the first inductor L1 and the second resistor R2 is connected to the HDMI receptacle 20. In some embodiments of the present disclosure, a capacitance value of the first capacitor C1 is, for example, 0.1 μF, and an inductance value of the first inductor L1 is, for example, 200 μH. In some embodiments of the present disclosure, the capacitance value, the resistance value, and the inductance value may be set based on the actual situation.

As shown in FIG. 4, in some embodiments of the present disclosure, the first rectifying circuit 101 may include a plurality of electrolytic capacitors TC1 and TC2 in parallel. In further embodiments of the present disclosure, the first rectifying circuit 101 may also include a plurality of ceramic capacitors C4, C5, and C6 connected in parallel with the plurality of electrolytic capacitors TC1 and TC2. Positive electrodes of the capacitors TC1, TC2, C4, C5, and C6 are coupled to the first power source V1, and negative electrodes of the capacitors TC1, TC2, C4, C5, and C6 are grounded.

The electrolytic capacitors have the advantages of large capacity per unit volume and low cost. The positive electrodes of the electrolytic capacitors TC1 and TC2 are coupled to the first power source V1 of the interface apparatus, and the negative electrodes of the electrolytic capacitors TC1 and TC2 are grounded. Therefore, the electrolytic capacitors may convert a pulsating DC voltage from the first power source V1 into a relatively stable DC voltage. Because the electrolytic capacitors have large resistance to a high frequency current, the plurality of ceramic capacitors C4, C5, and C6 may be connected in parallel with the electrolytic capacitors TC1 and TC2, to absorb high frequency interference. In one example, both the capacitance value of the electrolytic capacitor TC1 and the capacitance value of the electrolytic capacitor TC2 are 220 μF, both the capacitance value of the ceramic capacitor C4 and the capacitance value of the ceramic capacitor C5 are 1 μF, and the capacitance value of the ceramic capacitor C6 is 4.7 μF. The capacitance values of the electrolytic capacitor TC1 and TC2 and the capacitance values of the ceramic capacitors C4, C5, and C6 may also be other values. In some embodiments of the present disclosure, the above capacitance values may be set based on the actual situation. By connecting a plurality of capacitors in parallel, the ripple may be suppressed.

In some embodiments of the present disclosure, the second rectifying circuit 103 may include an electrolytic capacitor TC3. In further embodiments of the present disclosure, the second rectifying circuit 103 may also include a plurality of ceramic capacitors C7 and C8 connected in parallel with the electrolytic capacitor TC3. Positive electrodes of the capacitors TC3, C7, and C8 are coupled to the HDMI receptacle, and negative electrodes of the capacitors TC3, C7, and C8 are grounded.

In this embodiment, the capacitance value of the electrolytic capacitor TC3 and the capacitance values of the ceramic capacitors C7 and C8 may be set based on the actual situation. By connecting the electrolytic capacitor TC3 and the ceramic capacitors C7 and C8 in parallel, the ripple may be further suppressed.

In some embodiments of the present disclosure, the power supply circuit 10 may be coupled to a given pin of the HDMI receptacle 20. Thus, the given pin of the HDMI receptacle 20 may output the preset voltage to the external device coupled to the HDMI receptacle 20.

In some embodiments of the present disclosure, the HDMI receptacle 20 may use the Type A interface. An eighteenth pin of the Type A interface is the power output terminal. The given pin may be the eighteenth pin of the HDMI receptacle 20. The power supply circuit 10 is connected in series with the eighteenth pin of the HDMI interface. Thus, electrical functions of the eighteenth pin of the HDMI interface are not negatively affected, and power may be supplied to the compute stick through the eighteenth pin of the HDMI interface. Reference may be made to the prior art for the functions of other pins of the HDMI receptacle 20, and the detailed descriptions of those functions are omitted herein.

In some embodiments of the present disclosure, the HDMI receptacle 20 may be coupled to an HDMI plug of the external device. The interface apparatus outputs the preset voltage to the external device via the HDMI receptacle 20 and the HDMI plug of the external device. Furthermore, when the HDMI receptacle 20 of the interface apparatus is connected to the HDMI plug of the external device, a data signal also may be transmitted to the external device via other pins of the HDMI receptacle 20.

FIG. 5 illustrates a schematic block diagram of a display apparatus of an interface apparatus according to an embodiment of the present disclosure. The display apparatus may include the interface apparatus set forth in the above embodiments.

The display apparatus according to some embodiments may convert, via the power supply circuit, the first voltage into the preset voltage required for the external device. By providing the power source for the external device via the HDMI interface, the external device is not needed to be additionally equipped with an additional power adapter. Thus, using the interface apparatus not only saves costs, but also is convenient for use.

Each embodiment in the specification is described in a progressive manner, and each embodiment is focused on difference from other embodiments. Cross reference may be used for identical or similar parts among different embodiments.

In conclusion, it is to be noted that a relational term (such as a first or a second . . . ) herein is merely intended to separate one entity or operation from another entity or operation, rather than requiring or hinting any practical relation or sequence exists among these entities or operations. Furthermore, terms such as “comprise”, “include” or other variants thereof are intended to cover a non-exclusive “comprise” so that a process, a method, a product, or a device including a series of elements not only includes these elements, but also includes other elements not listed explicitly, or also includes inherent elements of the process, the method, the product, or the device. In the case of no more definitions, elements defined by a sentence “include a . . . ” do not exclude the fact that additional identical elements may exist in a process, a method, a product, or a device including these elements.

Embodiments of an interface apparatus and a display apparatus provided by the present disclosure are described in detail above. Elaboration of principles and implementations of the present disclosure is made by using specific examples herein. The description of the above embodiments is merely intended to assist in understanding the method of the present disclosure and the core concept thereof. Also, those of ordinary skill in the art may change, in accordance with the concept of the present disclosure, a concrete implementation and a scope of application. Therefore, contents of the specification of the present disclosure shall be not interpreted as limiting the present disclosure.

1. An interface apparatus comprising a power supply circuit and a high definition multimedia interface (HDMI) receptacle;
wherein the power supply circuit is coupled to a first power source and the HDMI receptacle, and is configured to convert a first voltage from the first power source into a preset voltage and provide the preset voltage to the HDMI receptacle; and
wherein the HDMI receptacle is configured to output the preset voltage to an external device coupled to the HDMI receptacle.

2. The interface apparatus according to claim 1, wherein the power supply circuit comprises a first rectifying circuit and a voltage conversion circuit, wherein the first rectifying circuit is coupled to the first power source and the voltage conversion circuit, and wherein the voltage conversion circuit is coupled to the HDMI receptacle;
wherein the first rectifying circuit is configured to rectify the first voltage and provide the rectified first voltage to the voltage conversion circuit; and
wherein the voltage conversion circuit is configured to convert the rectified first voltage into the preset voltage, and provide the preset voltage to the HDMI receptacle.

3. The interface apparatus according to claim 2, wherein the voltage conversion circuit comprises a direct current voltage converting chip.

4. The interface apparatus according to claim 2, wherein the first rectifying circuit comprises a plurality of capacitors in parallel, wherein a positive electrode of each of the plurality of capacitors is coupled to the first power source, and wherein a negative electrode of each of the plurality of capacitors is grounded.

5. The interface apparatus according to claim 2, wherein the power supply circuit further comprises a second rectifying circuit, wherein the second rectifying circuit is coupled between the voltage conversion circuit and the HDMI receptacle, and wherein the second rectifying circuit is configured to rectify the preset voltage and provide the rectified preset voltage to the HDMI receptacle.

6. The interface apparatus according to claim 5, wherein the second rectifying circuit comprises a plurality of capacitors in parallel, wherein a positive electrode of each of the plurality of capacitors is coupled to the HDMI receptacle, and wherein a negative electrode of each of the plurality of capacitors is grounded.

7. The interface apparatus according to claim 4, wherein the plurality of capacitors comprise electrolytic capacitors.

8. The interface apparatus according to claim 4, wherein the plurality of capacitors comprise electrolytic capacitors and ceramic capacitors.

9. The interface apparatus according to claim 6, wherein the plurality of capacitors in the second rectifying circuit comprise electrolytic capacitors and ceramic capacitors.

10. The interface apparatus according to claim 1, wherein the power supply circuit is coupled to a given pin of the HDMI receptacle.

11. The interface apparatus according to claim 10, wherein the given pin is an eighteenth pin of the HDMI receptacle.

12. The interface apparatus according to claim 1, wherein the HDMI receptacle is coupled to an HDMI plug of the external device, and wherein the preset voltage is provided to the external device via the HDMI receptacle and the HDMI plug.

13. The interface apparatus according to claim 1, wherein the external device is a compute stick.

14. A display apparatus comprising the interface apparatus according to claim 1.

15. The interface apparatus according to claim 3, wherein the first rectifying circuit comprises a plurality of capacitors in parallel, wherein a positive electrode of each of the plurality of capacitors is coupled to the first power source, and wherein a negative electrode of each of the plurality of capacitors is grounded.

16. The interface apparatus according to claim 3, wherein the power supply circuit further comprises a second rectifying circuit, wherein the second rectifying circuit is coupled between the voltage conversion circuit and the HDMI receptacle, and wherein the second rectifying circuit is configured to rectify the preset voltage and provide the rectified preset voltage to the HDMI receptacle.

17. The interface apparatus according to claim 4, wherein the power supply circuit further comprises a second rectifying circuit, wherein the second rectifying circuit is coupled between the voltage conversion circuit and the HDMI receptacle, and wherein the second rectifying circuit is configured to rectify the preset voltage and provide the rectified preset voltage to the HDMI receptacle.

18. The interface apparatus according to claim 17, wherein the second rectifying circuit comprises a plurality of capacitors in parallel, wherein a positive electrode of each of the plurality of capacitors is coupled to the HDMI receptacle, and wherein a negative electrode of each of the plurality of capacitors is grounded.

19. The interface apparatus according to claim 15, wherein the power supply circuit further comprises a second rectifying circuit, wherein the second rectifying circuit is coupled between the voltage conversion circuit and the HDMI receptacle, and wherein the second rectifying circuit is configured to rectify the preset voltage and provide the rectified preset voltage to the HDMI receptacle.

20. The interface apparatus according to claim 19, wherein the second rectifying circuit comprises a plurality of capacitors in parallel, wherein a positive electrode of each of the plurality of capacitors is coupled to the HDMI receptacle, and wherein a negative electrode of each of the plurality of capacitors is grounded.
